(19) United States
(12) Patent Application Publication
(10) Pub. No.: US 2006/0256567 A1
(43) Pub. Date: Nov. 16, 2006

(54) STRUCTURE FOR LIGHTING UNIT

(75) Inventors: Eric C. H. Chen, Hsin Chu Hsien (TW); Jim S. Powell, San Marcos, CA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: AU-LITE LIGHTING INC., Hsin Chu Hsien (TW)

(21) Appl. No.: 11/465,031

(22) Filed: Aug. 16, 2006

(30) Foreign Application Priority Data
Aug. 19, 2005 (TW) 094128530

(51) Int. Cl. F21V 19/00

(52) U.S. Cl. 362/382

(57) ABSTRACT

A structure for containing a lighting unit is provided. The structure includes a circular container having a circular slot, and a fixing unit having a clamp portion and a connector portion, wherein the connector portion is disposed in the circular slot and slidable therein.

### FIELD OF THE INVENTION

The present invention relates to a structure for a lighting unit, and more particular to a structure for a lighting unit for adorning various automobile headlights.

### BACKGROUND OF THE INVENTION

Nowadays the automobile headlight adorned with dazzling light is becoming more and more popular, and various ornamental lightings are therefore developed. The most popular lighting to adorn the automotive headlight at current time is the Angel Eye, which is configured by surrounding the automotive headlight with a lighting unit to highlight the headlight profile.

FIG. 1 shows a conventional structure for accommodating lighting unit. The structure includes a container 100 and a fixing unit 200. The container 100 is attached to a housing 6 of an automotive headlight 5 through the fixing unit 200. The automotive headlight 5 includes a lamp 50 and a reflector 52, and is attached to the automobile body (not shows) through the housing 6. The housing 6 is configured with an inclination portion 6a, a bottom portion 6b and a sidewall 6c. The container 100 is anchored to the bottom portion 6b and the sidewall 6c through the fixing unit 200 to compass the reflector 52. The profile of the automotive headlight 5 is therefore decorated by the lighting unit in the container 100.

Although the specification of the automotive headlight 5 is almost standardized in the commercial market, the medium for connecting the headlight 5 and the automobile body i.e. the housing 6 is various and the disposing portion thereof for locating the fixing unit 200 is different for each maker. For the conventional container 100, the location of the fixing unit 200 thereon is unchangeable for different housing 6. Thus, to install the Angel Eye to adorn the headlight 5 for different car patterns, the requirement of a variety of the structures for lighting unit with different configurations and sizes is unavoidable. It compels the parts vendor and the carmaker to suffer from the cost pressure due to the stocks of various types of the structures for lighting unist with various fixing units, thereby causing resource consumption.

According to the above description, a novel structure for a lighting unit is provided, and the disposition of the fixing unit thereon is adjustable to overcome the mentioned drawbacks in the prior art.

Thus, the main aspect of the present invention is to provide a structure for a lighting unit having an adjustable fixing unit for fitting different types of automobiles.

### SUMMARY OF THE INVENTION

According to one aspect of the present invention, a structure for containing a lighting unit is provided. The structure includes a circular container having a circular slot, and a fixing unit having a clamp portion and a connector portion, wherein the connector portion is disposed in the circular slot and slidable therein.

Preferably, the circular slot faker has a slot width, and the connector portion comprises a wide side and a narrow side, wherein while the narrow side is parallel to the slot width, the fixing unit is slidable along the circular slot, and while the wide side is parallel to the slot width, the fixing unit stops on the circular slot.

Preferably, the circular slot Per comprises a slot opening defining an opening width larger than the narrow side, and the fixing unit is disposed in a specific location of the circular slot through the slot opening.

Preferably, the circular slot further comprises a slot opening defining an opening width smaller than the narrow side, and the connector portion is blocked by an edge of the slot opening.

Preferably, the fixing unit further has a neck portion connected between the connector portion and the clamp portion.

Preferably, the clamp portion further comprises a first clamping piece and a second clamping piece, and a clamping space is formed therebetween.

Preferably, the first clamping piece has a clamping block thereon facing to the second clamping piece.

According to another aspect of the present invention, a structure for containing a lighting unit is provided. The structure includes a linear container having a linear slot; and a fixing unit having a clamp portion and a connector portion, wherein the connector portion is disposed in the linear slot and slidable therein.

Preferably, the fixing unit farther comprises a stopping direction and a sliding direction, wherein the fixing unit is slidable while the fixing unit is positioned along the sliding direction and stopped while the fixing unit is positioned along the stopping direction.

Preferably, the connector portion is urged against the linear slot when the fixing unit is positioned along the stopping direction.

Preferably, the connector portion further has a wide side with a length larger than a slot width of the linear slot, for urging against the linear slot to stop the fixing unit in the linear slot.

According to a further aspect of the present invention, a structure for containing a lighting unit is provided, The structure includes a container having a circular part, a linear part and a slot; and a fixing unit having a clamp portion and a connector portion, wherein the connector portion is disposed in the slot and slidable therein.

Preferably, the connector portion further comprises a wide side, and while the wide side is urging against the slot, the fixing unit is anchored in the slot.

Preferably, the clamp portion further comprises a first clamping piece and a second clamping piece, and a clamping space formed therebetween.

According to further another aspect of the present invention, a structure for containing a lighting unit is provided. The structure includes a container having a slot; and a fixing unit having a clamp portion and a connector portion, wherein the connector portion is disposed in the slot and slidable therein.

Preferably, the container is circular.

Preferably, the container is linear.

Preferably, the structure further includes a back cover covering the space containing the lighting unit therein.

Preferably, the connector portion comprises an extending part to urge against the slot and anchor the fixing unit at the slot.

According to filer another aspect of the present invention, a light system is provided. The light system includes a light source; a container containing the light source and having a slot; and a fixing unit having a clamp portion and a connector portion, wherein the connector portion is mounted in the slot and slidable therein.

Preferably, the slot is one of a circular slot and a linear slot.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic view of a conventional structure for a lighting unit;

FIG. 2 is an elevation view of the structure for a lighting unit according to a preferred embodiment of the present invention;

FIG. 3 is a cross-sectional view of the structure for a lighting unit shown in Fig, 2;

FIGS. 4(A)-4(D) are schematic views of a fixing unit according to a preferred embodiment of the present invention;

FIG. 5 is an elevation view showing the configuration of the structure for a lighting unit according to a preferred embodiment of the present invention;

FIG. 6 is an elevation view of a back cover according to a preferred embodiment of the present invention;

FIG. 7 is a cross-sectional view of a back cover covering the container according to a preferred embodiment of the present invention; and

FIG. 8 is a schematic view of the structure for a lighting unit applied to a headlight housing according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

To improve the problem of lacking installation flexibility for the conventional structure for the lighting unit to be used for the automobiles headlight, the present invention provides a novel structure with a remarkable installation and usage flexibility. The structure for the lighting unit of the present invention is easy to be adapted for various types of automobiles. Through the present invention, different structures for lighting units prepared for different car patterns in the prior art is no longer required.

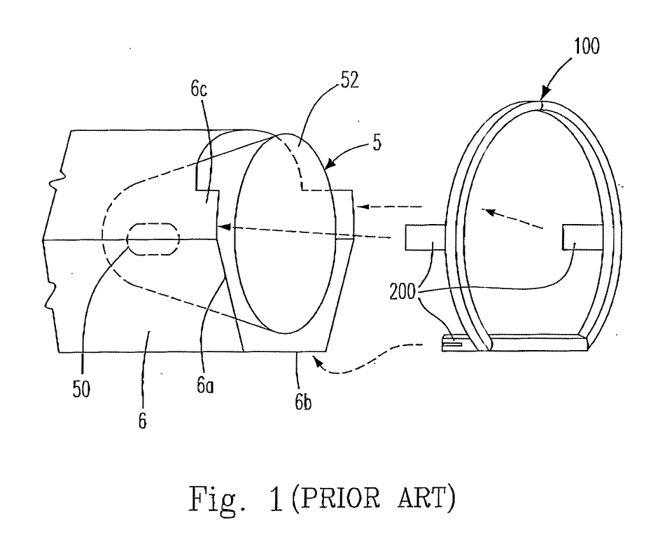

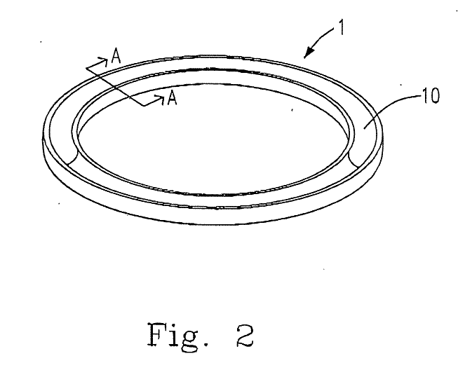

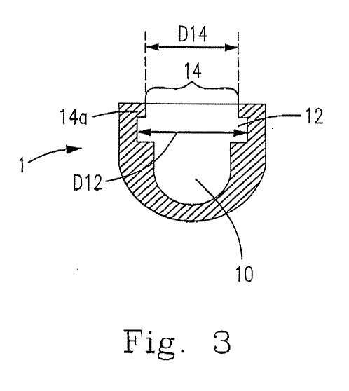

Please refer to FIG. 2, which shows an elevation view of a portion of the container 1 of the structure for the lighting unit according to a preferred embodiment of the present invention. The structure shown in FIG. 1 is generally a circular structure; however, it also can be a linear structure or a structure in an arbitrary shape. In the container 1, a containing space 10 is arranged therein to accommodate a lighting unit (not shown), and a slot 12 (as shown in FIG. 3) is formed on the inner-wall of the container 1. Basically, the container 1 is shaped to fit the lighting unit to be accommodated therein, and the containing space 10 and the slot 12 are formed according to the shape of the container.

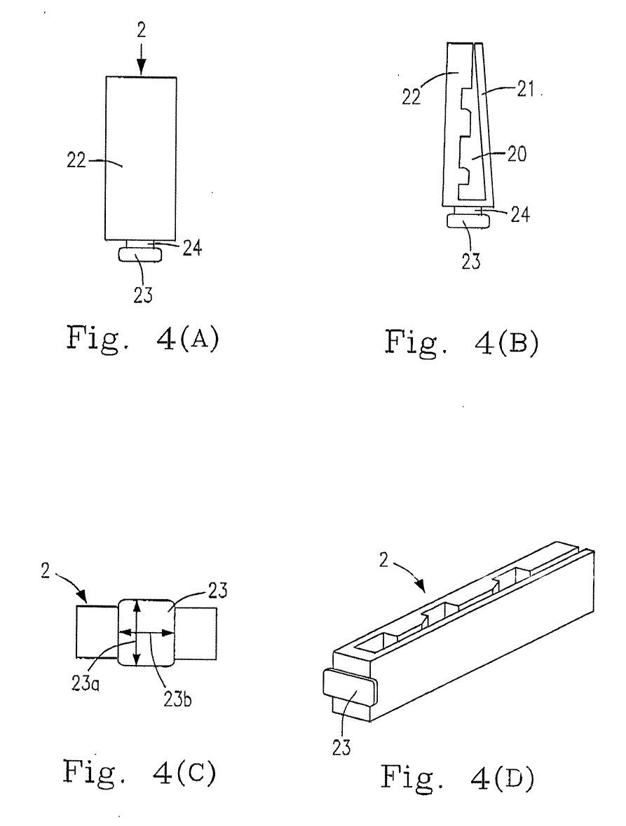

To distinctly describe the arrangement of the containing space 10 and the slot 12, the cross-sectional view along A-A of FIG. 2 is shown in FIG. 3. It is apparent that the container 1 is almost a hollow configuration comprising a containing space 10 and an opening 14 to accommodate the lighting unit (not shown). The present invention is different from the prior art in that a slot 12 is formed on the inner-wall of the container 1 and located between the opening 14 and the containing space 10. Please refer to FIGS. 4(A)-4(D), which are schematic views showing a fixing unit according to a preferred embodiment of the present invention, in which, FIG. 4(A) is a front view of the fixing unit 2, FIG. 4(B) is a side view thereof, FIG. 4(C) is a bottom view thereof and FIG. 4(D) is an elevation view thereof. The fixing unit 2 shown in FIGS. 4(A)-4(D) is disposed in the slot 12 shown in FIG. 3 and slidable therein. The fixing unit 2 includes a first clamping piece 21 and a second clamping piece 22, and a clamping space 20 is formed therein., In addition, a connector portion 23 is formed on a neck portion 24 of the fixing unit 2. The connector portion 23 is used to engage with the slot 12 and movable therein, and the location of the fixing unit 2 on the container 1 is therefore changeable

Please refer to FIGS. 3 and 4(A)-4(D). The connector portion 23 of the filing unit 2 shown in FIG. 4(C) is configured with a wide side 23a and a narrow side 23b. The slot 12 shown in FIG. 3 has a width D12; however, the wide side 23a shown in FIG. 4(C) is longer than the width D12. Thus, to attach the fixing unit 2 to the container 1, only the wide side 23a is needed to be orientated perpendicular to the inner-wall of the containing space 10, i.e. the wide side 23a is orientated to parallel with the width D12 of the slot 12, for urging against the slot 12, and the fixing unit 2 is therefore anchored thereon by the friction force resulting from the clipping effect applied on the connector portion 23 by the slot 12 with elastic deformation. By contrast, the narrow side 23b is shorter than the slot width D12, and thus when the narrow side 23b is disposed perpendicular to the inner-wall of the containing space 10, i.e. the narrow side 23b is orientated to align with the slot width D12, the connector portion 23 of the fixing unit 2 is loosened in the slot 12 and movable therein. In the practical application, the loosened fixing unit 2 moves along the slot 12 to the desired location in the container 1, and then is orientated to urge the connector portion 23 against the slot 12 and fixed therein. Accordingly, the structure for the lighting unit of the present invention possesses the installation flexibility to be adapted for various car patterns in addition, to enhance the attachment between the connector portion 23 and the slot 12, an adhesive or a screw fastener are recommended to be applied thereon.

In FIG. 3, the opening 14 arranged for the slot 12 of the container 1 is used to allow the lighting unit (not shown) to be accommodated in the containing space 10. The width D14 of the opening 14 shown in FIG. 3, is smaller than the narrow side 23b shown in FIG. 4, and thus the connector portion 23 loosened in the slot 12 is able to be kept therein. The connector portion 23, the neck portion 24 and the clamping pieces 21 and 22 are integrated into the fixing unit 2 for holding the structure for the lighting unit on the automobile headlight.

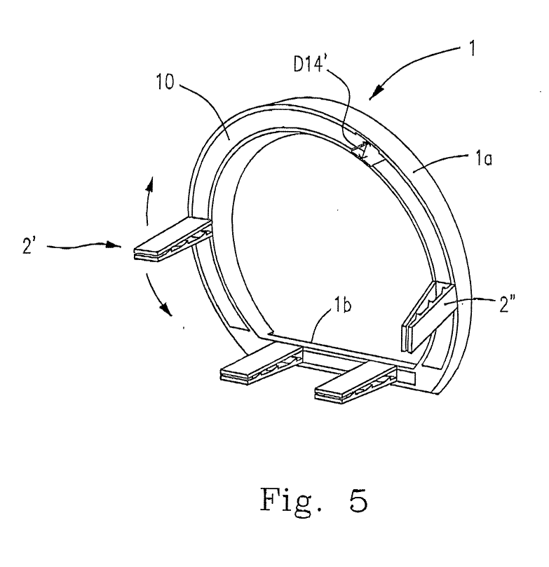

FIG. 5 is an elevation view showing the configuration of the structure for the lighting unit according to a preferred embodiment of the present invention. The structure for the lighting unit is a combination of the container 1 and the fixing units 2′ and 2″. In FIG. 5, the width D14′ of an arbitrary portion of the opening 14 is larger than the narrow side 23b of the connection portion 23. Through the width D14′, the fixing unit 2 (not shown) is inserted into the slot 12 and movable therein, and a desired location on the container 1 for attaching the fixing unit 2 is accessible. Accordingly, when an anchoring location is determined, the orientation of the loosened fixing unit 2′ is changed into that of the fixing unit 2″ to urge the connector portion 23 against the slot 12 and anchored thereon.

FIG. 5 also shows that, the container 1 comprises a circular portion 1a and a linear portion 1b, and the containing space 10, the slot 12 and the opening 14 as shown in FIG. 3 are accordingly formed therein. The cross-sectional view of the circular portion la and the linear portion 1b is shown in FIG. 3.

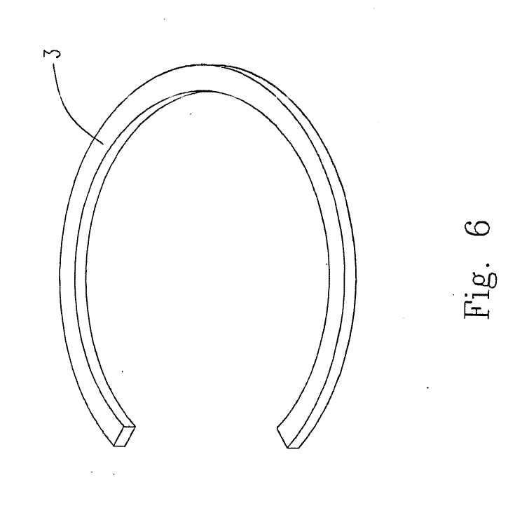

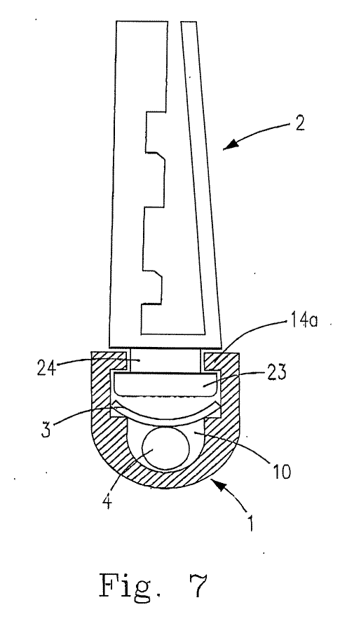

FIGS. 6 is an elevation view of a back cover according to a preferred embodiment of the present invention. FIG. 7 is a cross-sectional view of the configuration of the back cover covering the container according to a preferred embodiment of the present invention. The back, cover 3 shown in FIG. 6 is pre-bent to urge against the slot 12, as shown in FIG. 7, so as to keep the lighting unit in the containing space 10 and prevent it from being departed from the container 1 due to disturbance, such as shock or vibration. FIG. 7 shows that, the fixing unit 2 is anchored to the structure 1 through the connector portion 23 urging against the slot 12, and the neck portion 24 of the fixing unit 2 is mating with the opening 14 shown in FIG. 3. The circular back cover 3 shown in FIG. 6 is fit for the circular portion 1a of the container 1, and another linear back cover (not shown) is fit for the linear portion 1b of the container 1.

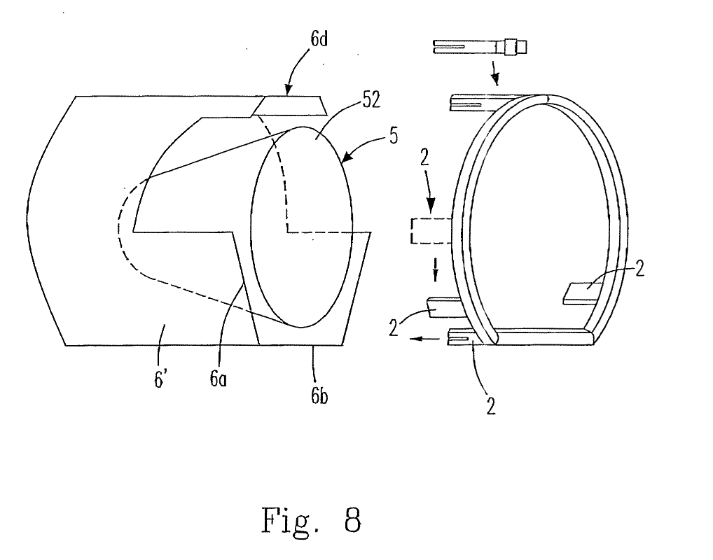

According to the above description, the fixing unit 2 of the structure for the lighting unit of the present invention is movable along the slot 12, and able to be disposed on the desired location on the container 1 to fit for a variety of automotive headlights. FIG. 8 is a schematic view of the structure for the lighting unit applied to a headlight housing according to a preferred embodiment of the present invention. The housing 6′ shown in FIG. 8 is slightly different from the housing 6 shown in FIG. 1. The housing 6′ includes an inclination portion 6a, a bottom portion 6b and an upper portion 6d, but lacks the sidewall 6c shown in FIG. 1. In application, the fixing unit 2 moves to a proper location in the slot 12 to clamp the structure for the lighting unit of the present invention to the inclination portion 6a of the housing 6′. Furthermore, the fixing unit 2 can be arranged on the container 1 to clamp the upper portion 6d of the housing 6′ to enhance the attachment strength between the container 1 and the housing 6′. It is apparent that, owing to the merits of the novel design of the movable fixing unit 2 and the sliding slot 12 in the container 1, the structure for the lighting unit of the present invention possesses a remarkable flexibility and is adaptable for various kinds of automotive headlights. Therefore, from the application viewpoint, the cost pressure resulting from stocking various types of the structures with various fixing units for a variety of headlights is alleviated. In addition, the structure for the lighting unit of the present invention is easy to be attached to the headlight housing, just by changing the orientation of the fixing unit 2 in the slot 12. Therefore, it is easy for the automobile owner to install the Angel Eye on his automobile. Additionally, an adhesive can be used to reinforce the attachment between the connector portion 23 and the slot 12. Accordingly, the structure for the lighting unit of the present invention is simple and convenient for the automobile owner. Hence, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A structure for containing a lighting unit, comprising:
a circular container having a circular slot; and
a fixing unit having a clamp portion and a connector portion, wherein the connector portion is disposed in the circular slot and slidable therein.

2. The structure as claimed in claim 1, wherein
the circular slot further has a slot width; and
the connector portion comprises a wide side and a narrow side, wherein while the wide side is perpendicular to the slot width, the fixing unit is movable along the circular slot, and while the wide side is parallel to the slot width, the fixing unit stops on the circular slot.

3. The structure as claimed in claim 2, wherein the circular slot further comprises a slot opening defining an opening width larger than the narrow side, and the fixing unit is disposed in a specific location of the circular slot through the slot opening.

4. The structure as claimed in claim 2, wherein the circular slot further comprises a slot opening defining an opening width smaller than the narrow side, and the connector portion is blocked by an edge of the slot opening.

5. The structure as claimed in claim 1, wherein the fixing unit further has a neck portion connected between the connector portion and the clamp portion.

6. The structure as claimed in claim 1, wherein the clamp portion further comprises a first clamping piece and a second clamping piece, and a clamping space is formed therebetween.

7. The structure as claimed in claim 6, wherein the first clamping piece has a clamping block thereon facing to the second clamping piece.

8. A structure for containing a lighting unit, comprising:
a linear container having a linear slot; and
a fixing unit having a clamp portion and a connector portion, wherein the connector portion is disposed in the linear slot and slidable therein.

9. The structure as claimed in claim 8, wherein the fixing unit further comprises a stopping direction and a sliding direction, wherein the fixing unit is slidable while the fixing unit is positioned along the sliding direction and stopped while the fixing unit is positioned along the stopping direction.

10. The structure as claimed in claim 9, wherein the connector portion is urged against the linear slot when the fixing unit is positioned along the stopping direction.

11. The structure as claimed in claim 10, wherein the connector portion further has a wide side with a length larger than a slot width of the linear slot, for urging against the linear slot to stop the fixing unit in the linear slot.

12. A structure for containing a lighting unit, comprising:
a container having a circular part, a linear part and a slot; and
a fixing unit having a clamp portion and a connector portion, wherein the connector portion is disposed in the slot and slidable therein.

13. The structure as claimed in claim 12, wherein the connector portion further comprises a wide side, and while the wide side is urging against the slot, the fixing unit is anchored in the slot.

14. The structure as claimed in claim 12, wherein the clamp portion further comprises a first clamping piece and a second clamping piece, and a clamping space is formed therebetween.

15. A structure for containing a lighting unit, comprising:
a container having a slot; and
a fixing unit having a clamp portion and a connector portion, wherein the connector portion is disposed in the slot and slidable therein.

16. The structure as claimed in claim 15, wherein the container is circular.

17. The structure as claimed in claim 15, wherein the container is linear.

18. The structure as claimed in claim 15, further comprising a back cover covering the space containing the lighting unit therein.

19. The structure as claimed in claim 15, wherein the connector portion comprises an extending part to urge against the slot and anchor the fixing unit at the slot.

20. A light system, comprising:
a light source;
a container containing the light source and having a slot; and
a axing unit having a clamp portion and a connector portion, wherein the connector portion is mounted in the slot and slidable therein.

21. The light system as claimed in claim 20, wherein the slot is one of a circular slot and a linear slot.
